(19) United States
(12) Patent Application Publication
(10) Pub. No.: US 2019/0134496 A1
(43) Pub. Date: May 9, 2019

(54) Simplified Craps Game with a Color Coded and or Related Coded System of Wagering, Utilizing a Pay Grid Multiplier Payout and Bonus Bets

(71) Applicant: R. Douglas Ferrario, St. Louis, MO (US)

(72) Inventor: R. Douglas Ferrario, St. Louis, MO (US)

(21) Appl. No.: 15/998,267

(22) Filed: Jul. 26, 2018

Related U.S. Application Data
(60) Provisional application No. 62/605,101, filed on Aug. 1, 2017.

(51) Int. Cl. A63F 11/00; A63F 9/04; G06F 3/0488

(52) U.S. Cl. CPC A63F 11/0074; A63F 11/0051; A63F 9/0413; A63F 2011/0072; G06F 3/04883; A63F 2011/0088; A63F 9/0402

(57) ABSTRACT

A portable craps game incorporating a color-coding or other indicia system of wagering, which includes a game mat, the game mat incorporating various sections, for participatory play, including a pay grid, a roll area, placed bets area, a pass bets area, and a location for field bets during game play. The game is played with 1-6 players, and a dealer, and each player commits to selection of one of the colors or indicia in front of them, which committed to color remains with the player during participation in the said game. The player also selects the coloration in the pay grid area, so that the odds can increase, during participation in the game, so long as the player participates and is successful in their selection of the placed bets area. The throw of the dice by the various participants generally progresses clockwise around the game mat, during participation in this portable craps game. The game mat may be a pair of back-to-back tables, with a divider provided therebetween, and the pay grid area may be electronically displayed upon the divider.

### CROSS REFERENCE TO RELATED APPLICATION

This non-provisional patent application claims priority to the provisional patent application having Ser. No. 62/605,101 filed on Aug. 1, 2017.

### FIELD OF THE INVENTION

This invention relates to a craps game, either permanent or portable, and one that incorporates a color-coding system or other means of identification for application during wagering, wherein each player is identified by a unique indicia to have an interactive system of wagering. The game can be provided upon a table, or a portable sheet, in preparation for play. Bets are made by the players, and when the dice is thrown, the pay grid provided upon the surface of the game table indicates the amount of increased payout, to a winning party or parties, after each accumulative roll, and/or whether said pay grid multiplier increases the reward. The game tables are available in both a digital and non-digital format. A screen provided behind the table and its roll area displays data for the pay grid multipliers and the multiple bonus bets. Also, a pair of tables may be installed back-to-back, for usage.

### BACKGROUND OF THE INVENTION

The story goes that, the game of Craps was invented by Sir Williams of Tyre, in 1125 AD during the Crusades. Sir Williams and his troops came upon a castle which was named “Asart” or “Hazarth.” While laying siege to the castle, they played the dice game called Hazarth.

The game of Hazarth started to catch on throughout the world by the end of the 18^{th} century. The French embraced the game, and brought it to New Orleans in the US for gamblers to enjoy. “7” was the most common number, but when the two dice were rolled representing a 1 and a 1, it was called “crabs eyes.” This is now the modern day “snake eyes.” Through poor translation, “crabs eyes” became “craps.” (Hence, the Bonus Bet being called Crab Run.) The original game was very complicated with different odds and payouts.

The most modern game of craps we have all come to know and love was designed by John W. Winn (Hence the Bonus Bet now being called the Winnfall or Combination Bet). He introduced the ability to bet against the shooter, which changed the layout and the selection of bets available. Betting with the house “the do nots” often creates a poor atmosphere at the table, with players betting against one another. This simplified game eliminates this style of play. It was thought that having more choices for making wagers translated to more fun. However, our simplified craps game will prove that easy to understand, simplified, knowing where to place wagers, interactive game will be more entertaining and enjoyable.

The final evolution of the game from Winn was known as Bank Craps, more commonly known today in casinos as Craps. Today Craps has become probably the most popular and exciting games in American casinos. The casino games continue to evolve and have numerous bonus bets and different bets depending on which casino you are in.

Oddly enough, craps is not as popular in Europe as it was 500 years ago. However with its increased popularity, it will probably go full circle and become popular once again. The irony is that this game will help it go full circle from the early Castle to your Castle. Meaning also a portable and simplified game you can play with friends in your own home.

This invention will address the two main limitations of playing craps:
1. Traditional craps game tables are large and bulky which would require a dedicated room to play. The answer: this invention measuring 24″×36″ can be rolled out on any bar counter, table, floor, etc., and be easily transported and put away.
2. The game of Craps is a complicated game to play for the novice player, and is often intimidating to play in casinos. It is even more complicated for someone to deal and know the odds and payouts for so many different wagers. This invention has simplified the amount of wagers available, simplified the system of play with a color coded or other indicia interactive system of play for the players, while still maintaining the integrity of Craps and keeping it fun and relatively easy to play.

3. But, this game can also be embodied upon the standard type of craps game table, and provide a multitude of positions for players, up to six, as shown upon the preferred embodiment, but can also include playing positions for even more players, should a larger table be employed, or even a lesser number.

From a patent standpoint, the prior art does disclose U.S. Pat. No. 5,078,404, that shows a portable gaming table. This is a gaming table that is applied as a craps table, but not near as complex nor structurally assembled as the craps game as played in a casino.

U.S. Pat. No. 6,655,689, shows another craps game improvement. It is generally played in the manner of a craps game, wherein other players place their bets before the shooter throws the dice during performance of the game.

U.S. Pat. No. 5,839,960, shows a table for playing a game of Chance. While this game apparently includes the throw of a dice during its application, the layout of its board appears to be somewhat similar to that for the playing of Black Jack, as known in the art.

U.S. Pat. No. 6,464,225, shows a further method and apparatus for playing a dice game. It does utilize the conventional aspects of playing a game of craps, while simplifying the betting options for the participants.

Finally, U.S. Pat. No. 4,247,114, shows a board game, wherein its playing surface includes a center area, wherein dice may be rolled, and various spaces around its periphery for establishing the betting areas for the participants. While the dice are rolled within the center section, there is an aspect of the various betting areas being identified by the color of one of the dice, during its usage and application.

### SUMMARY OF THE INVENTION

This invention relates primarily to a Simplified Craps Game with a Color Coded and or Related Coded System of Wagering, Utilizing a Pay Grid Multiplier Payout and Bonus Bets. Simplified, and interactive as players are able to place their own wagers with their unique identifier, and with a limited number of ways of betting from a traditional craps game. This will be easier for players to see what bets are available, and to better understand their payout. Because of the simplification, the game will be easily monitored using 1-2 dealers. Because of the pay grid multiplier, placed wagers can be paid out at the end versus after every roll, keeping a simpler, better, and faster flow of play. Some knowledge of the game of craps is beneficial, but not necessary.

The game will be played as a single table game, or casinos will have the option to convert one existing craps table into two separate games and tables with a middle divider and slight table modifications, to have two table games in the same footprint. As mentioned, this game will be available in both a digital and non-digital versions. Differences between the two will be how the multiplier is recorded, and differences in bonus bets.

The non-digital table will utilize a pay grid directly on the surface of the game table, which is adjusted by the dealer who moves acrylic or other markers down the grid accordingly, as each number is rolled. For this non-digital version, the multiplier may also be recorded through other mechanical or manual means such as dials, pegs, rollers, cards, etc., with future designs of the existing concept to keep track of rolled numbers. Think of it as how some baseball stadiums still record hits, outs, runs, etc. on a score board versus electronically. The bonus bet may include a 4-10 before 7 bonus bet, or other specified numbers.

The digital table will utilize a digital or electronic screen behind or above the roll area, and will be populated with data for the pay grid multipliers and bonus bets. All data will be entered electronically by a dealer after each roll from an electronic device alongside the table. The bonus bets may include a Streak bonus bet, and a Combination bonus bet, which will be discussed in greater detail following. Other bonus bets may be added in the future.

The game will follow similar rules to the traditional game of craps with some differences. The following bets are available in this simplified craps game: Pass Line, Placed Bets, Hard Ways, Field Bets, and Bonus Bets. This game does not utilize the “Don't” as all players have the same agenda of beating the house. Players will place their own wagers when given the opportunity to do so at the dealer's discretion. When the dealer gives the okay, players will place their own bets on their unique color and/or unique icon using actual casino chips. Similar to how they would place bets in the game of roulette, but differing in that the chips being placed are actual casino chips versus chips representing a dollar amount. Dealers may also assist in placing bets for participants that are unable to reach certain bets on the table. Bonus bets are always placed by the dealer only.

Also, this invention relates to primarily a simplified craps game, which may also be portable. Portable from the standpoint that everything needed to play the game is enclosed in a lightweight and easy to carry 3″ diameter by 24″ long plastic tube, more or less. (Game mat, poker chips, spacers, and dice included). Simplified, with a unique color-coded or indicia system of wagering where each player has a unique color or code to have an interactive system of wagering. Simplified also with a limited number of ways of betting from the real craps game in casinos, which is easier for the player to understand, and allow for a single person to act as the dealer (House), and maintain a better flow of play. Some knowledge of the game of Craps is beneficial but not necessary. This is a fun game for beginners and experienced players alike. Suggested for two to six players, or more, one of which would be the dealer (House). Never has a portable craps game been so much fun and easy to play at home or on the go.

The game is established as a structural mat, or formed for application to a table, having the indicia for playing this modified game of craps thereon, and which includes its game mat, generally in the category of a 24″×36″ sheet. The mat includes a pay grid, that provides for movement of various spacers downwardly, each time a number, through the roll of the dice, is established. The mat also includes a roll area, in its upper corner reaches, but obviously, the dice rolling areas could be located anywhere around the periphery of the mat. The mat includes a place bets area, wherein the participating players and the option to bet various numbers, represented by the roll of dice, and to achieve an early payout, during participation in the game. There is also a past bet area, wherein if select numbers come up during an initial roll, funds are paid out to the participant, that have placed their bets at these locations.

The board also includes provision for participating in bonus bets, in field bets, in the roll of aces, such as snake eyes, or box cars, comprising a roll of the number 12. Other areas provide for one time wagering, anytime wagering, during participation within the play of the game.

This simplified game improves several key limitations of the traditional game of craps:
The compact, simplified, and unique design layout creates an interactive system of wagering, and better enables a player to know where bets can be made, through the color coded and/or unique icon coded system of wagering, allowing players to place their own wagers. Different betting options are surrounded by each player's color or unique icon, for ease of understanding.
A pay grid that is established using a multiplier for placed bet payouts, from a rounded percentage similar to the payout of the existing odds for craps. Pay grid payout levels can be set to any number of rolls from two to infinity. Actual multipliers may also be adjusted with the gaming boards permission.
4-10 before 7, Streak, and Combination Bonus Bets, all can be made. This invention further relates to a simplified craps game, one that focuses on the most common wagers in craps, while eliminating other more confusing betting options. This invention incorporates a color coded and, or unique icon system of wagering, where each player is identified with their own unique color or icon to have an interactive system of wagering. Players will place their wagers accordingly to this color/icon appropriately across the playing surface. This simplified layout is played on a table roughly ½ the size of a traditional craps table. Table dimensions vary from 42′-50′ wide to 72′-84′ long. Depending on the size of the table, the game will accommodate 1-8 players. In the existing layout, 6 players are available. (More players depending on the size of the table, where additional spots may be added, and 1 to 2 dealers).

This simplified version has also created the ability for the first time ever to convert one existing craps table on a casino floor to two separate games, with simple modifications such as adding a divider in the middle of the table and replacing the existing felt layout. Dice will be thrown in one direction down the table towards the middle. We also have the option to create a stand alone table, roughly half the length of a traditional table.

Placed bets are paid out using a pay grid multiplier. This pay grid multiplier is a unique and significant improvement of the existing game of craps. Traditionally players are confused when and where to place their bets, and have a difficult time understanding their payout such as traditional 7 to 6, 7 to 5, 9 to 5 for placed bets. Players through the implementation of the pay grid will simply multiply their placed bet on their unique spot times the multiplier achieved through the successful rolling of a number before a 7 comes up. Payouts will be at the end of the roll versus after each individual roll, keeping a more consistent flow of play.

Three unique bonus bets may be incorporated onto the playing surface, which will be discussed in the body of this patent. (4-10 Before 7, Streak Bet and Combination Bet). Other additional bonus bets may be added in the future.

Game tables are available in both a digital and non-digital format. The non-digital table utilizes a pay grid directly on the surface of the game table, that is adjusted by a dealer by moving acrylic markers, under each number 4,5,6,8,9 & 10, down the grid accordingly, as numbers are rolled. Other mechanical measures such as pegs, dials, flip cards, sliders, etc. may be incorporated to keep track of rolled numbers with future manual devices. The digital table will utilize a digital/electronic screen behind the roll area that will be populated with data for the pay grid multipliers and bonus bets. A dealer will be responsible for inputting rolled dice results from a device alongside of the table. This simplified and improved game improves several key limitations of the traditional game of craps. The original provisional patent for this simplified version of craps has been expanded upon while keeping the original intellectual property. The provisional patent was for a craps game layout, incorporating a portable, at home version. The same key benefits and improvements can be applied to any layout applicable in a casino, home, or even a digital screen such as a phone or computer application. The same significant improvements from the original patent application are:
Compact, simplified and unique design layout, creates an interactive system of wagering, and better enables a player to know where bets can be made, through a color coded and/or unique icon coded system of wagering, allowing players to place their own wagers. Different betting options are surrounded by each player's color or unique icon, for ease of understanding.
A pay grid that is established utilizing a multiplier for placed bet payouts, from a rounded percentage similar to the payout of the existing odds for craps. Pay Grid payout levels can be set to any number of rolls from 2-infinity. Actual multipliers may also be adjusted with the gaming boards permission.
4-10 Before/Bonus Bet, Streak Bonus Bet, and Combinations Bonus Bets.
Ability to convert one existing casino table into two separate games with simple table modifications of a divider in the middle of the existing table, and replacing the felt layout.

It is, therefore, the principal object of this invention where a portable craps game is provided with a color-coded game of wagering, where each player is identified by its own coloration or indicia, during participation in a series of differing types of wagering that can be made, depending upon the positioning of the chips, upon the game mat, and the location of the wagering of valued chips, upon the surface of the mat during participation in the roll of dice during playing of the portable craps game.

Another object of this invention is to provide a pay grid area upon a game mat, where the dealer may initially add at the beginning the introduction of a spacer upon the grid, and then advance through various elevated degrees of payment, as continued participation in the game and roll of the dice is undertaken.

A further object is to present an improved craps game that can be applied onto a standard game table.

Another advantage of this craps game is the application of electronics and digital applications to the game table.

A further object of this invention is to provide a simplified craps game focusing on the most common wagers of a traditional table, and eliminating others, with a modified layout for ease of understanding and play.

Another object of this invention is to utilize a coding system of wagering. Whereas, players can easily understand what bets are available to them around the play surface base of their unique icon, or color coded chip, and is interactive for them in placing their own wagers. This is similar to how they would traditionally place a Field Bet on their own.

A further object of the invention is to provide a pay grid multiplier that is used to keep track of rolled numbers, based off a rounded percentage of traditional craps odds for placed bets. Instead of using 7-6, 6-5, and 9-5, a multiplier is used to calculate their winnings at the end of a roll, versus after every roll, to keep a smooth consistent flow of play. Players will be paid out at the end of the roll by multiplying the dollars wagered times the multiplier achieved through the successive rolling of a number before a 7 comes up, on the dice.

A further object is to provide for the first time a game that allows the conversion of one existing craps table on a casino floor to two separate games that can or cannot be played simultaneously. This can be achieved with simple modifications such as adding a divider in the middle of the table and replacing the existing table felt. Dice will be thrown in one direction down the table towards the middle. A divider may or may not have a digital monitor built into it, depending upon if it is a digital layout or not.

A further object is to provide an improved table layout that adds the option for a single stand alone table, roughly half the length of a traditional craps table, similar to a craps tub.

A further object is to provide a new layout that creates the opportunity for a play at home version, which is much easier for the single dealer to manage, when employed.

Another object is to provide a new layout that creates the opportunity for an easier to understand and play digital version online and in a phone app.

Yet another object is to provide a primary bet of 4-10 before 7 bonus bet. On a come out roll, if the player rolls each of the 4,5,6,8,9, or 10, before a 7, the player achieves success. Players betting this type of bonus are paid out at 11-1 odds.

A further object is to provide a Streak Bonus Bet. This bet can be made after any 7. This bonus bet is simply how many rolls can be made before a 7 comes up. A streak. Players are paid out accordingly for reaching higher levels, by the roller rolling other numbers than 7. This bet is explained in greater detail in the body of the specification. Finally, another object is to provide a Combination Bonus Bet. This bet can be made only after any 7. This bonus bet is achieved by individually rolling all 18 combinations of dice before a / is rolled. This bet is usually kept track of on a digital screen version. For success of all 18 combinations, players have the opportunity to win 5,000 to 1. Other variations to this bet may include payouts at different levels of achievement, such as 3-18 levels.

These and other objects may become more apparent to those skilled in the art upon review of the summary of the invention as provided herein, and upon undertaken a study of the description of its preferred embodiments, in view of the drawings.

### BRIEF DESCRIPTION OF THE DRAWINGS

In referring to the drawings:

FIG. 1 is a plan view of the game board or play surface layout for the non-digital version of the craps game of this invention, and further showing the pay grid multiplier payout and the additional bonus bets components;

FIG. 1A discloses the bonus bet schematic as noted;

FIG. 1B shows the come roll bets, schematic, of the game board as noted;

FIG. 1C discloses the pay grid multiplier as noted in FIG. 1;

FIG. 1D discloses the field schematic of the game board as noted in FIG. 1;

FIG. 1E discloses the schematic for payout of the number come easy schematic disclosed in FIG. 1;

FIG. 1F shows the payout point system for each player as disclosed in FIG. 1

FIG. 2 shows a modified layout for the craps game of this invention, with the addition of two different bonus bets features;

FIG. 2A shows the crap run bonus bet as shown in FIG. 2;

FIG. 2B shows the windfall bonus bet as disclosed in FIG. 2;

FIG. 3A shows the crab run bonus bet of the digital/electronic screen incorporated into the game board of this invention;

FIG. 3B shows the placed bets schematic of the digital/electronic screen incorporated into the game board;

FIG. 3C discloses the Winnfall Bonus Bet incorporated into the digital/electronic screen of the game board;

FIG. 4A shows the approximate layout, size-wise, of the playing table, craps surface, for the craps game of this invention;

FIG. 4B provides an approximate layout dimensionally for a double playing surface for the craps game of this invention;

FIG. 5 provides a graphic display of how the actual craps payouts are rounded up, or down, to simplify the payout utilizing a multiplier showing various numbering values;

FIG. 6 shows further game payouts;

FIG. 7 shows a chart of further game payouts, during participation in performance of the craps game;

FIG. 8A provides one of the accessories, the tube, for holding the portable craps game of this invention;

FIG. 8B is an end cap for the shown tube;

FIG. 8C is a plastic inner tube used in packaging of the portable game board;

FIG. 8D is another end cap;

FIG. 8E is a one dollar poker chip;

FIG. 8F is a five dollar poker chip;

FIG. 8G is a twenty-five dollar poker chip;

FIG. 8H is a one hundred dollar poker chip;

FIG. 8I is an acrylic spacer;

FIG. 8J shows one dice used in the craps game;

FIG. 9 shows the game map, and the layout of its various sections, that provides the complete display of the various sections of the game, for portable play, in preparation for participation in the game of craps;

FIG. 10 shows a further modification to a non-digital gaming table;

FIG. 11 shows a non-digital gaming table, where the table is made up of two craps games, similar to that in FIG. 1, having a dividing wall located between the two;

FIG. 12 discloses the layout for a digital gaming table;

FIG. 13 discloses a digital gaming table made up of two craps tables, similar to that shown in FIG. 11, arranged back-to-back with the dividing wall therebetween, and mounting the data displays for the bonus wagers; and

FIG. 14 shows a standard board for the game of craps, as available in the prior art.

### DESCRIPTION OF THE PREFERRED EMBODIMENT

The various components that make up the structure of this simplified craps game can be readily identified upon review of the various drawings provided herein. The game mat can be seen upon its surface, and the various sections that compose it, where the participants apply their various bets with casino chips on their own identifying color or unique icon. Betting options are surrounded by a color or unique icon. Availability of the betting locations are easily identified during participation in the simplified craps game of this invention. Payouts and the payout multiplier are clearly posted on the game mat for each optional bet for ease of understanding. Size and location of the bets available in this craps layout may vary in size, location, color, etc., depending on the table design.

In the various figures, select numbers correspond to various locations and sections upon the game mat, board, or felt, identifying the various betting options and categories available to the participant in the craps game. For example, the letter 101 relates to the pay grid multiplier area, where noted.

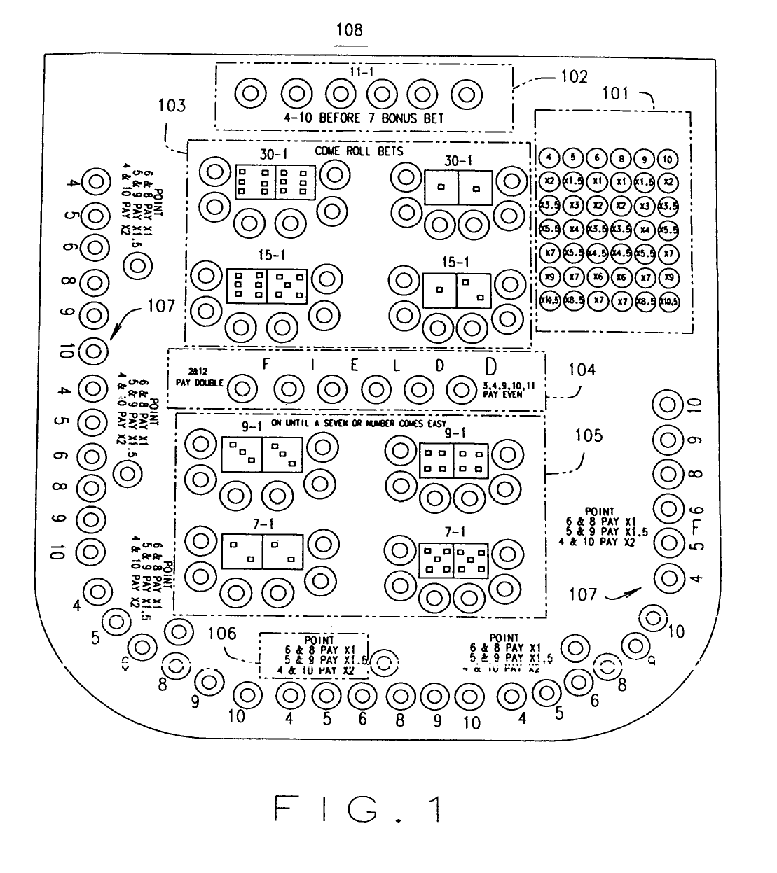

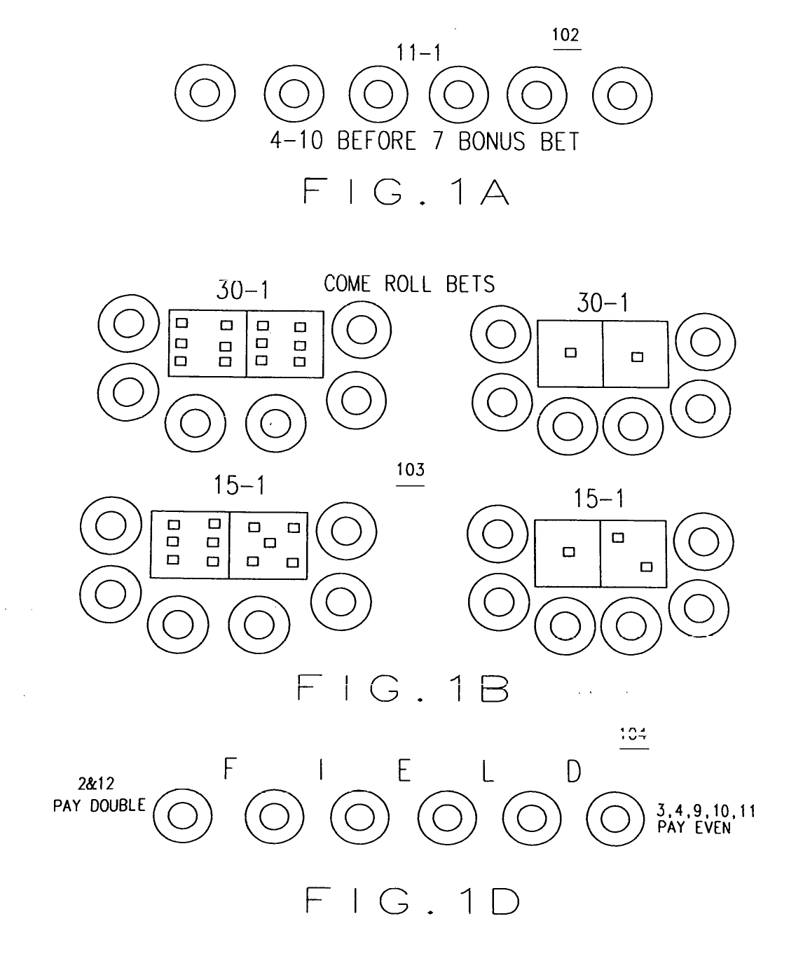

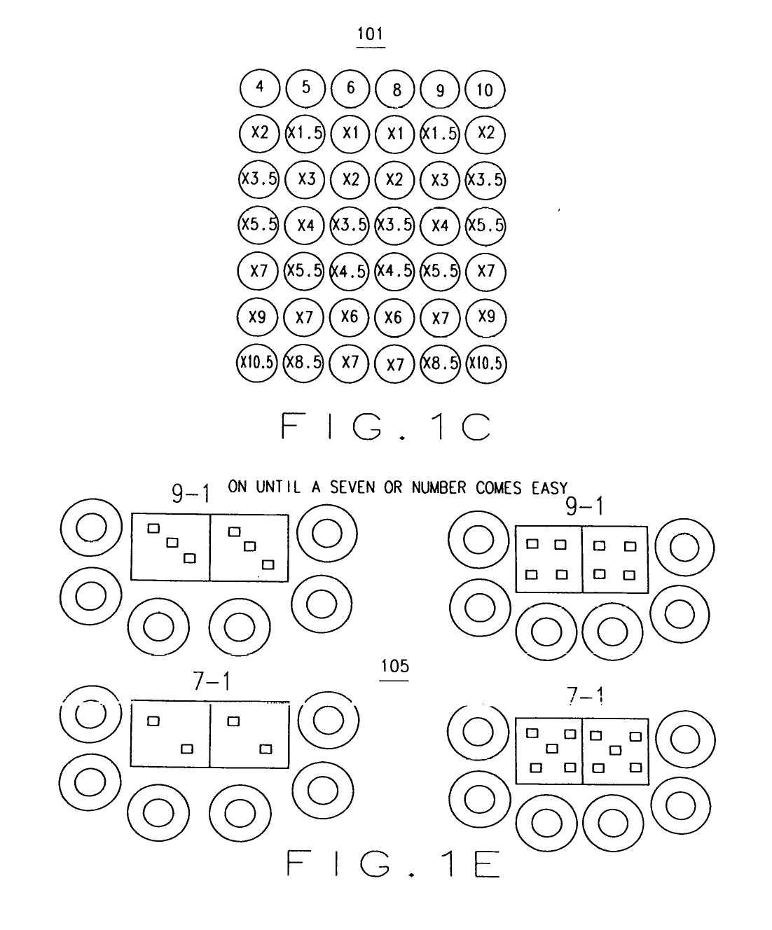

### FIG. 1: Non-Digital Layout 101-107

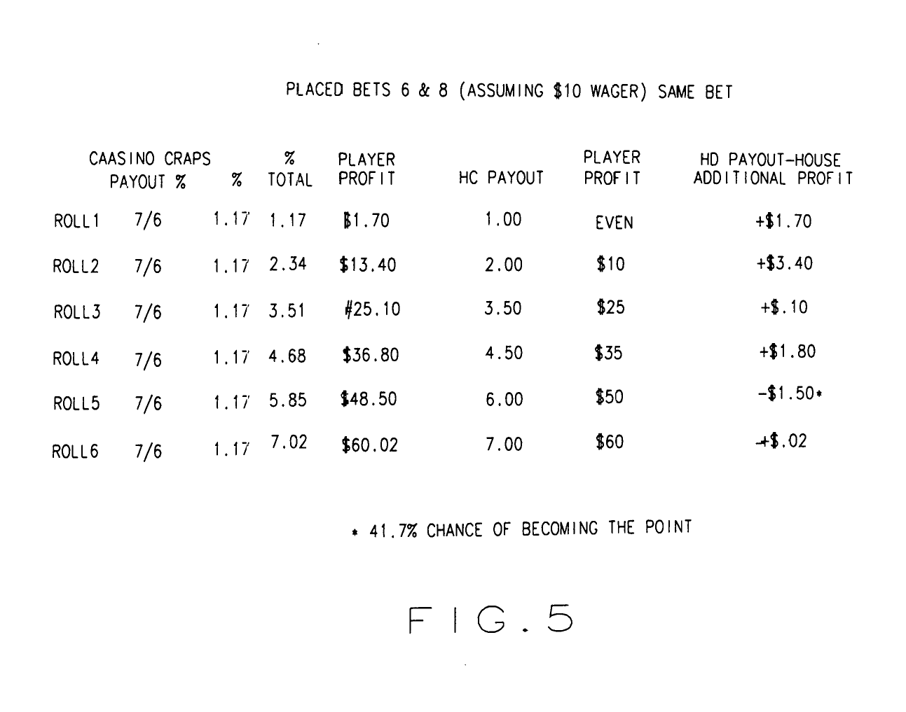

A. Pay Grid. Already established multiplier for numbers rolled, identified at 101, as in FIG. 1 and FIG. 1C, also noted at said 101. Acrylic spacer moves down one space at a time, as the number is rolled. Multiplier is established from a rounded percentage similar to the payout of the existing game of craps. Some numbers are rounded up or down depending on the calculated odds. For this non-digital version, players are paid out when one of these things happen: Point is hit, 7 out, or a number has been rolled 6 times and reaches the end of the pay grid. (Payout levels may be between two to infinity). Smaller payout levels such as 2 or 3, allow tor increasing their bet on that number quicker versus waiting for 4+ rolls. When reaching the end of the pay grid, players are paid out, and the acrylic spacer is moved in relation to the 4-10 Before 7 Bet, as noted at 102. Players making “Placed Bets” may only place bets until the corresponding number makes the pay grid. Because of this betting nature, pressing placed bets in not allowed in this simplified game. For additional information on how multipliers are established, please see FIG. 5. Also, for this non-digital type of craps game, and its disclosed table, obviously, the numbers being played, and being displayed upon the pay grid area, can be recorded by other mechanical means, besides the identified acrylic spacer, such as through the use of dials, pegs, sliders, etc., as additional methods to mechanically keep track of the rolled dice, and the number of rolls, for disclosure upon the shown pay grid area, and the bonus bets.
B. Hard Ways. (One roll bet). This area, identified at 103, incorporates the various combinations and payouts indicated on the play surface. The 12 & 2 are paid out at 30-1. 11 & 3 are paid out at 15-1. Bets in this area are either collected or paid out after each roll. These bets may also be made before any roll. These can be seen in FIG. 1 and FIG. 1B.
C. Hard Ways. (On until a seven, or number comes easy). This is noted at 105, in FIG. 1 and FIG. 1E. The hard 6 & 8 are paid out at 9-1, while the hard 4 & 10 are paid out at 7-1. These bets stay available until a seven is rolled, or the number comes easy. Easy meaning the total is achieved by something different than identical pairs. These bets may be made before any roll.
D. Field. Identified at 104, as seen in FIG. 1 and FIG. 1D. (One roll bet). 3, 4, 9, 10, and 11 pay even money. 2 & 12 pay double. This bet may be made before any roll.
E. Pass Bet. Noted at 107, in FIG. 1. Players place a bet here at the start of the game (Come out roll). If a 7 or 11 comes up on the initial roll, they are paid even money. If a 2, 3, or 12 come up, the bet is lost. Once a point has been established (4, 5, 6, 8, 9, or 10) that becomes the number to hit before a 7. The points are paid out as follows: 6 & 8×1, 5, & 9×1.5, and 4 & 10×2. Backing the pass bet is not available in this simplified game.
F. Placed Bets. For each of the players, as noted at 106, in FIG. 1F. After a point has been established, players can make a bet on these numbers. Players can bet these numbers up until the time the number has been rolled and reaches the pay grid. These bets are paid out according to a multiplier of how many times that particular number is rolled. These bets are paid out only after a point is made, 7 out, or reaching the end of the pay grid. These bets should always be made in even increments, as multipliers are not paid out in cents, and if necessary, are rounded down to the nearest dollar.
G. 4-10 Before 7 Bonus Bet, as again noted at 102, in FIG. 1 and FIG. 1A. This bet must be placed before any point is established, or numbers have reached the pay grid. If the player rolls each the 4, 5, 6, 8, 9, 10 before a 7. Players are paid out at 11-1 when this happens. If a point is made before a 7, acrylic spacer moves directly on the number, indicating it has already been rolled in relation to this bet. Acrylic spacers start out behind the number initially. This bet is only paid out one time per roll.
H. Roll Area. Area for the roll of dice, as noted at 108, in FIG. 1. Usually divided from the rest of the table with an acrylic shield, but not mandatory. Dice should hit the back wall (rubber pyramid), and come to rest in this area to be considered a good roll.

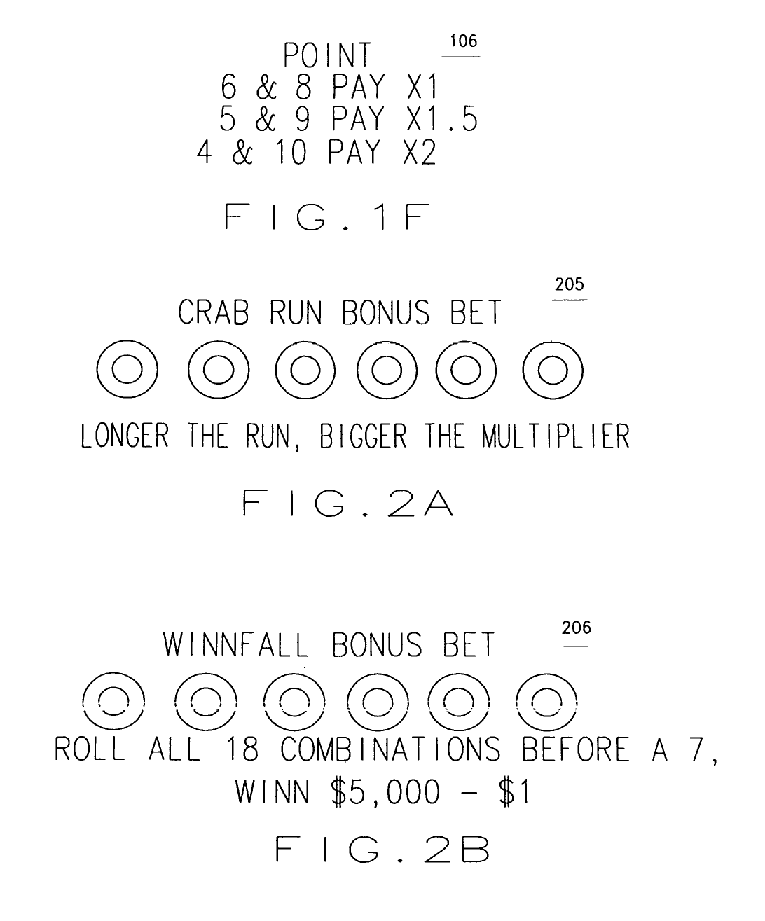

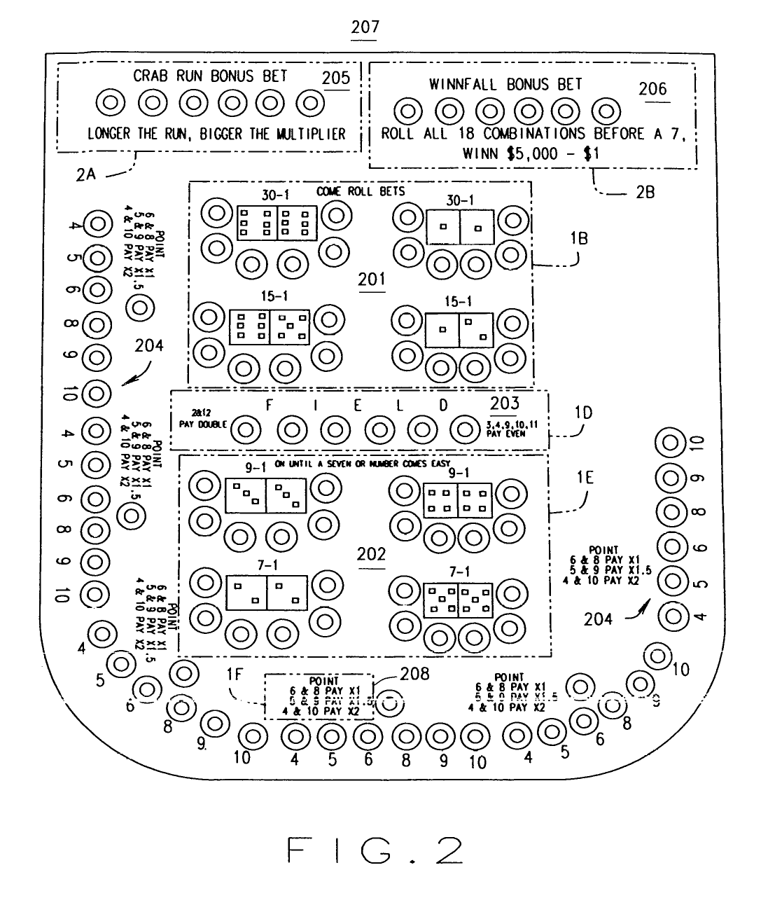

### FIG. 2: Digital Layout 2A-2K

Hard Ways. (One roll bet). This area, as noted at in FIG. 2, at No. 201, incorporates the various combinations and payouts indicated on the play surface. The 12 & 2 are paid out at 30-1. 11 & 3 are paid out at 15-1. Bets in this area are either collected or paid out after each roll. These bets may also be made before any roll.

Hard Ways. (On until a seven, or number comes easy). The hard 6 & 8 as noted at 202, are paid out at 9-1, while the hard 4 & 10 are paid out at 7-1. This is shown in FIG. 2, at said No. 202. These bets stay available until a seven is rolled, or the number comes easy. Easy meaning the total is achieved by something different than identical pairs. These bets may be made before any roll.

Field. (One roll bet) 3, 4, 9, 10, 11 pay even money. 2 & 12 pay double. This may be made before any roll. This is shown also in FIG. 2 at No. 203.

Pass Bet. Players place a bet here at the start of the game. (Come out roll). If a 7 or 11 comes up on the initial roll, they are paid even money. If a 2, 3, or 12 come up, bet is lost. Once a point has been established (4, 5, 6, 8, 9, or 10) that becomes the number to hit before a 7. The points are paid out as follows: 6 & 8×1, 5 & 9×1.5, and 4 & 10×2. Backing the pass bet is not available in this simplified game. This is shown in FIG. 2, at No. 208.

Placed Bets. After a point has been established, players can make a bet on these numbers. Players can bet these numbers up until the time the number has been rolled and reaches the pay grid. These bets are paid out according to a multiplier of how many times that particular number is rolled. These bets are paid out only after a point is made, 7 out, or reaching the end of the pay grid. These bets should always be made in even increments, as multipliers are not paid out in cents, and if necessary, are rounded down to the nearest dollar. See FIG. 2, at No. 204.

Crab Run Bonus Bet. This bet can be made only after any 7. See FIG. 2, at No. 205. This bonus bet is simply how many rolls can be made before a 7 comes up. A streak. For 5 rolls without a 7 is paid out at ×1.5, for 10 rolls without a 7 is paid out at ×5, for 15 rolls without a 7 is paid out at ×12, for 20 rolls without a 7 is paid out at ×35, for 25 rolls without a 7 is paid out ×80, and for 30+ rolls without a 7 is paid out at 200-1. Cumulative, not paid out on each level. Odds may be adjusted according to approval from the gambling board. This Bonus Bet can also be expanded to continue perpetually with increasing payouts if desired.

Actual odds are: (Needs verification from gambling board)

| | |
|---|---|
| 5 rolls | times 2.49% |
| 10 rolls | times 6.19% |
| 15 rolls | times 15.41% |
| 20 rolls | times 38.34% |
| 25 rolls | times 95.40% |
| 30+ rolls | times 237.38% |

Windfall Bonus Bet. This bet can be made only after any 7. See FIG. 2 at No. 206. This bonus bet is achieved by rolling all 18 combinations of dice before a 7 is rolled. Indicated on the digital screen. When this is accomplished, players are paid out at 5,000-1. Other variations to this bet may include payouts at different levels of achieving, such as 3-18 levels. As an example, there can be a payout multiplier for 8 combinations, 10 combinations, 14, or an amount therein up to the 18 combinations.

Actual odds are: 1-7,431. (Needs verification from gambling board).

Roll Area. Usually divided from the rest of the table with an acrylic shield, but not mandatory. See FIG. 2 at No. 207. Dice should hit the back wall (rubber pyramid), and come to rest in this area to be considered a good roll.

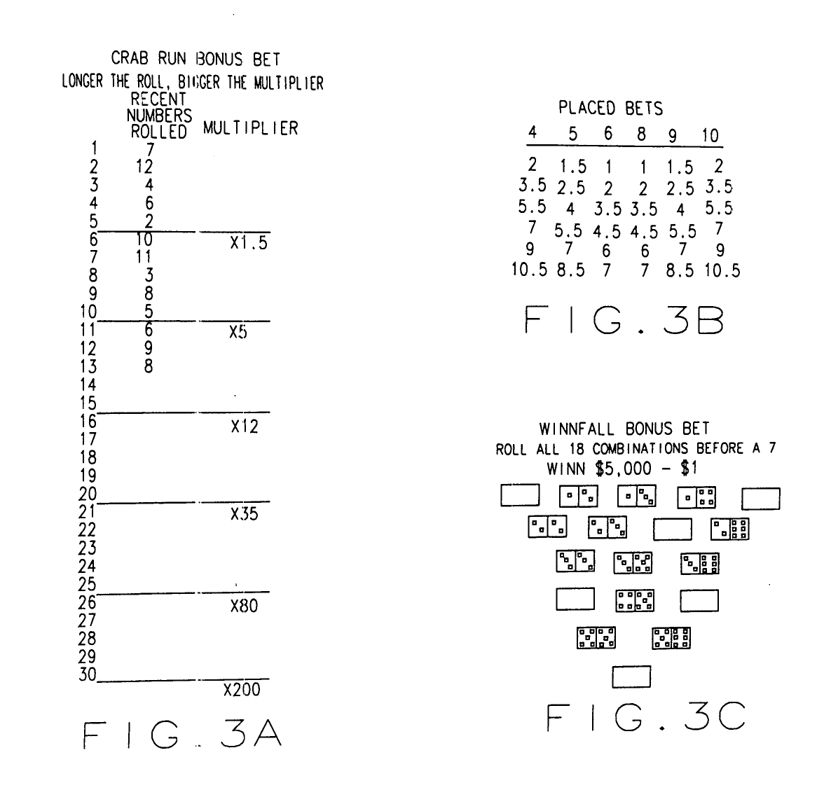

### FIG. 3: Digital Layout Screen

2I. Streak Bonus Bet. Digital screen representation for numbers rolled according to this bonus bet. Allows for tracking of totals rolled in succession. See FIG. 3A.

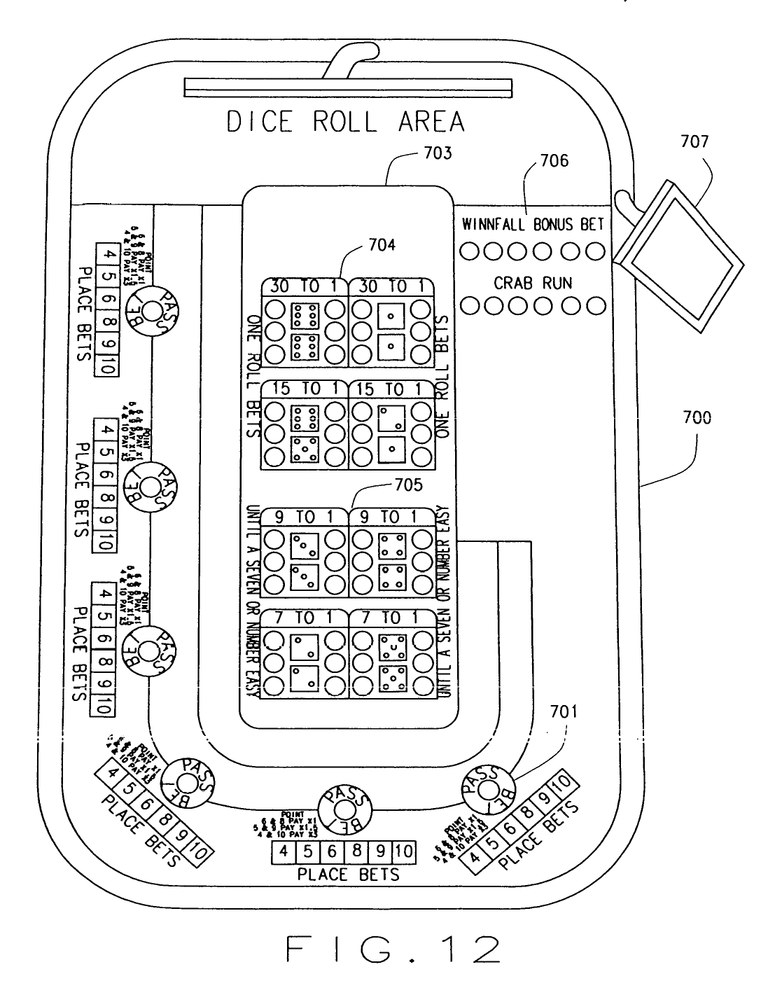

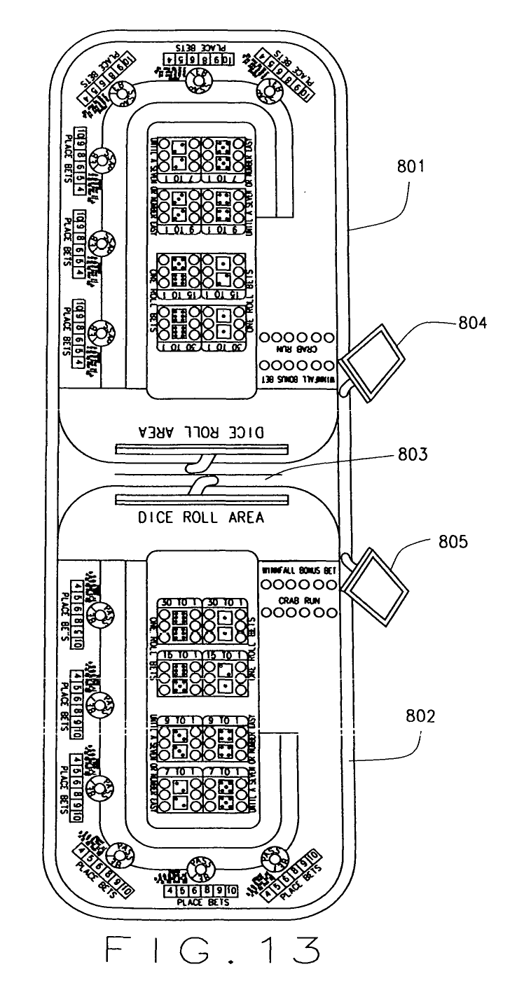

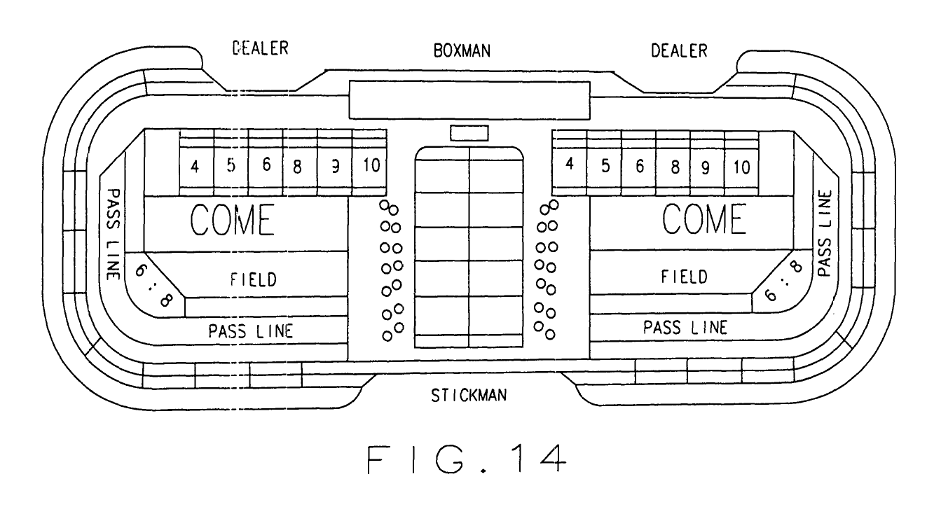

Pay Grid. Already established digital multiplier for numbers rolled. Multiplier is established from a rounded percentage, similar to the payout of the existing game of craps. See FIG. 3B. Some numbers are rounded up or down depending on the calculated odds. For this digital version, players are paid out when one of 2 things happen: Point is hit, 7 out. Multipliers go on to infinity in this digital version, and do not reach “the end of the pay grid.” Placed bets will be paid out according to the appropriate multiplier. Because of this betting nature, pressing placed bets in not allowed in this simplified game. For additional information on how multipliers are established, please see FIGS. 5-7. Also, for the digital form of table, such as shown in FIGS. 12 and 13, where the pay grid area may be electronically displayed at the ends of the shown tables, it can be seen that there are touch screen input devices, where noted, that will be regulated and operated by the dealer(s) to keep track of the rolled numbers, and once the dealer applies select data upon the input device, such information will be displayed upon the digital screen somewhere above the roll area, for displaying information relative to the digital Pay Grid and other bonus bets undertaken during play.

Windfall Bonus Bet. Digital representation of 18 different combinations of dice to be rolled for a payout. See FIG. 3C. As combinations are rolled, they will become marked accordingly. The payout for accomplishing all 18 combinations before a 7 is 5,000-1. Other variations to this bet may include payouts at different levels of achievement, such as 3-18 levels. As an example, there can be a payout multiplier for 8 combinations, 10 combinations, 14 or an amount therein, up to the 18 combinations. (Needs verification from gambling board).

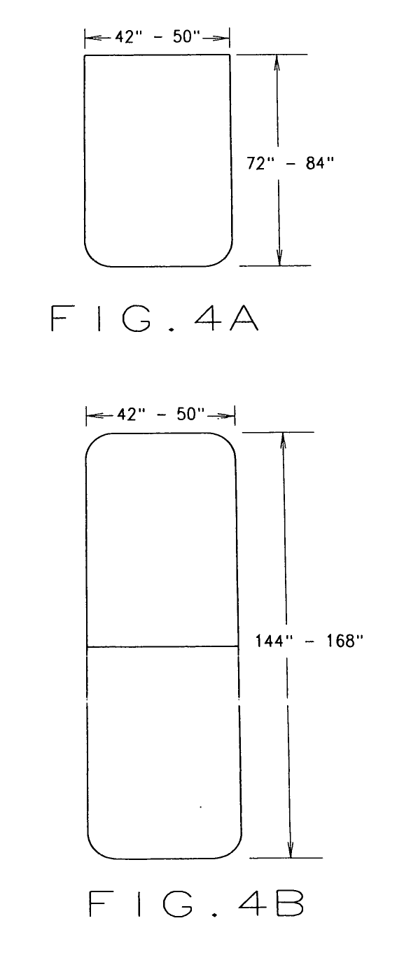

### FIG. 4: Felt/Mat Layout Approximate Dimensions of 4A-4B

4A. Single Table Layout. Approximate dimensions 42″-50″ wide by 72″-84″ long. Color, cosmetic design, and material to be determined.
4B. Converted Existing Craps Table to 2 Simplified Tables. (Approximate overall dimensions depending on the existing table size). 42″-50″ wide by 144″-168″ long. Color, cosmetic design, and material to be determined.
4B. A two game table may be provided two tables arranged back-to-back, for simultaneous play, having a divider provided in the middle and against which the dice may be rolled, from either direction. The divider may also hold and support the various digital and electronic displays particularly relating to the dealer functioning of the pay grid areas, such as previously described with respect to the FIG. 1A embodiment, and as hereinafter described.

### FIG. 5: Pay Grid Multiplier Explanation

Pay Grid Multiplier Explanation. Pay grid is established using rounded numbers from actual craps odds to provide simplification. Some numbers are rounded up or down depending on the calculated odds. The number combinations of 6 & 8 are calculated at a 7 to 6 payout (1.17%) multiplier payout. The number combinations of 5 & 9 are calculated at a 7 to 5 payout (1.40%) multiplier payout. The number combinations of 4 & 10 are calculated at a 9 to 5 payout (1.80%) multiplier payout. If you take the number of rolls X the %, it gives you a number that is either rounded up or down. Multipliers may be adjusted up or down with review and/or permission from the gambling board. Because of the complicated payout structure of craps, this simplified version if the first to express it in an easy to understand multiplier payout.

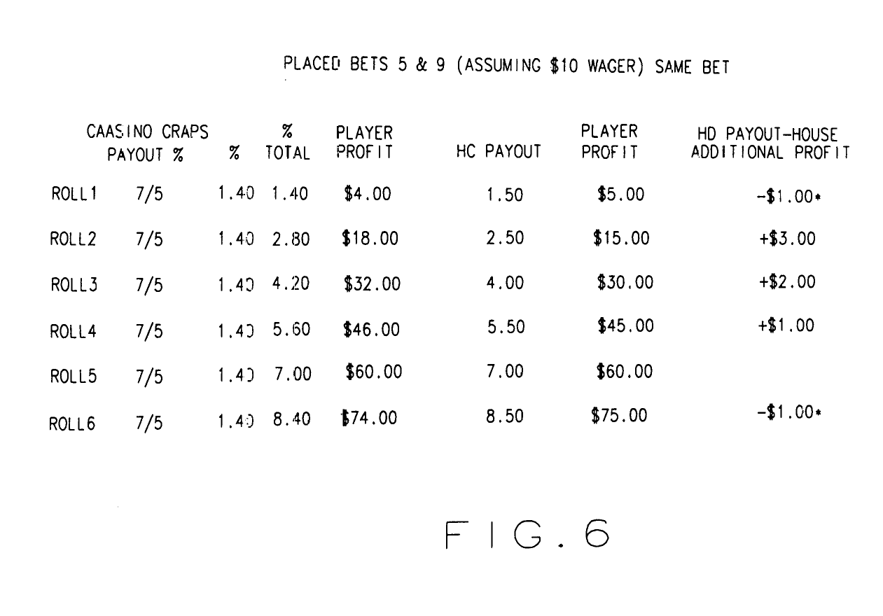

### FIG. 6: Further Pay Grid Multiplier for Bets Placed on 5 & 9

This particular figure shows the payout, through the pay grid, where the number combinations are 5 & 9, as noted.

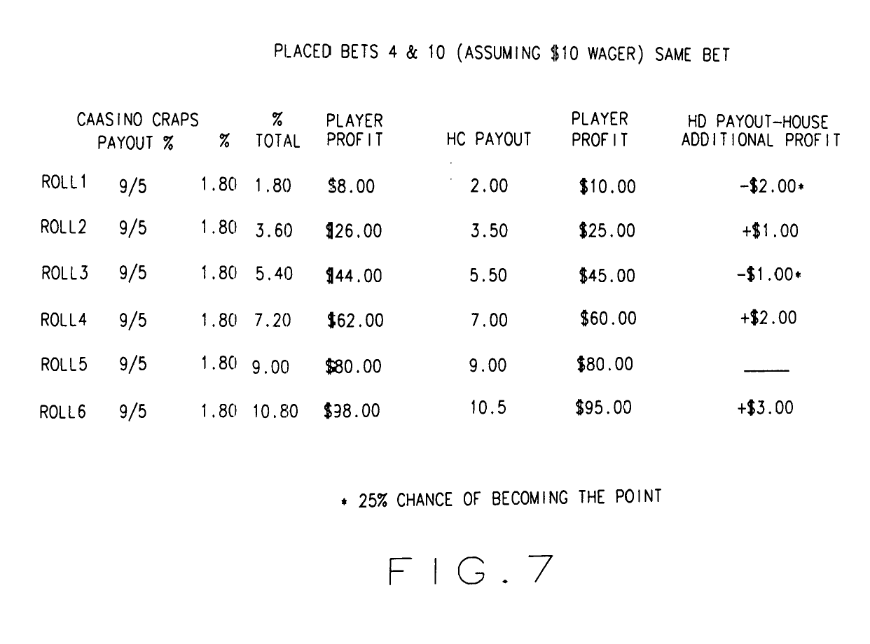

### FIG. 7: Further Pay Grid Multiplier

FIG. 7 shows the pay grid multiplier, where the combination of numbers played are 4 & 10, as previously explained with respect to the FIG. 5 chart.

### Game of Play

This simplified game of craps is played on a table roughly half the size of the traditional crabs table. Dice are thrown in one direction on the table, with a roll area that may be separated by a clear divider.

Players take turns throwing the dice in a clockwise direction around the table.
Game can be played with 1-8 players depending on the size of the table. (Additional color, unique icons, or indicia for additional players may be added for larger tables).
The game is played with similar rules as the traditional game of craps with the elimination of some less popular bets and some slight differences to be addressed forthcoming.
The “Don'ts” are not available in this game.
Both dice are rolled at the same time and must hit the back wall to be a good roll decided by the dealer.
All Bonus Bets must be made prior to a point being made, or numbers established in the pay grid. (After any 7). Minimums may be established for Bonus Bets depending on the casino.
Player rolling must place a “Pass Line” bet to be eligible to roll the dice.
If a 7 or 11 is rolled, players win even money on their pass bet. If 2, 3 or 12 is rolled, players lose their pass line bet. If a 4, 5, 6, 9, 9 or 10 is rolled, that number becomes the point. When the point is rolled before a 7, it is paid out as follows: 6 & 8×1, 5 & 9×1.5, 4 & 10×2. Bonus Bets come down after any 7, and are paid out if appropriate.
After a point has been established, each player has the option to make placed bets on any of the remaining numbers that are not the point. (4, 5, 6, 8, 9, 10), by placing an even dollar amount (table minimum) directly on the placed bet corresponding mark. Players are allowed to modify these bets only up to the time that the number establishes itself on the pay grid. Because of the nature of the game, pressing bets is not available in this game. Plan accordingly and bet big from the beginning! Placed bets are not paid out after every roll. These bets are paid out when 1 of 2 things happen in the “digital game”: 7 out, or a point is hit. For the non-digital table, a 3^{rd} payout is required if the number is rolled 6 times (may vary on payout levels), and needs to be reset at the top of the pay grid again.
The one roll hard way bets can be bet at any time, and are paid out immediately according to the odds listed.
The second group of hard way bets that stay up until a 7 or number comes easy. Easy meaning a total that is not represented by identical pairs. These bets may be made and modified at any time. These bets are paid out immediately according to the odds listed.
Field Bets can be made at any time, and are paid out immediately. This is a one time bet that pay even money on a 3, 4, 9, 10 or 11 and ×2 on a 2 or 12.

### For the Dealer

This simplified table game is played with 1-2 dealers.
Players will be responsible for placing their own bets when allowed to do so, and may receive assistance from time to time from the dealer if they are unable to reach the bet they are wishing to make.
In a 2 dealer system, the dealer to the lower section of the table will be responsible for helping to explain and place bets, paying out the field and the hard ways, and paying out placed bets when appropriate, and of course collecting bets lost.
This dealer will also be responsible for watching for any inappropriate or dishonest wagering.
The dealer at the top of the table will be responsible for dice retrieval and distribution, placing and monitoring the bonus bets, and entering rolled numbers in a digital device alongside the table, that will populate on the digital/electronic screen behind or above the table. This dealer may also be responsible for recording rolled numbers and combinations using mechanical/manually marking through other devices. This dealer will also be responsible for watching for any inappropriate or dishonest wagering.
Bonus bets are always placed by dealers only.

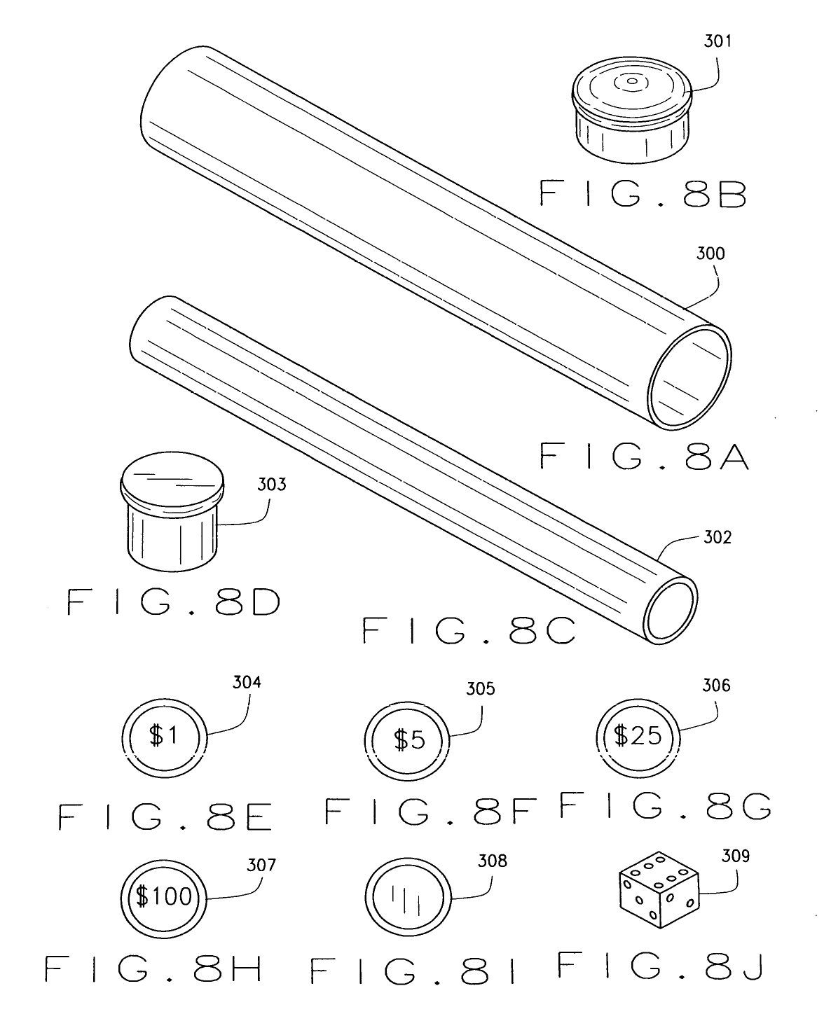

The various components that make up the structure of this shown modification for the “portable” craps game can be readily identified upon review of the various drawings provided herein. For example, a list of its components, and the identification of the components through alphabet reference characters, can be seen in FIG. 8A through 8J as follows:

### FIG. 8 Components (For Portable Game.)

300 Plastic outer tube 24″ long×3″ diameter, more or less.

301 Vinyl end caps 1½″ long×3″ diameter.

302 Plastic inner tubes 12″ long×1⅝″ diameter.

303 Vinyl end caps 1½″ long×1⅝″ diameter.

304 Standard white 1½″ diameter $1 poker chips.

305 Standard red 1½″ diameter $5 poker chips.

306 Standard green 1½″ diameter $25 poker chips.

307 Standard black 1½″ diameter $100 poker chips. (Total poker chips dollar value $1,540)

308 1½ acrylic spacer (One of which with translucent color).

309 ¾ dice.

The make up of the game mat can be seen upon its surface, and the various sections that compose it, where the participants apply their various spacers, betting chips, and the availability of the locations where these components can be applied, during participation in the portable craps game of this invention.

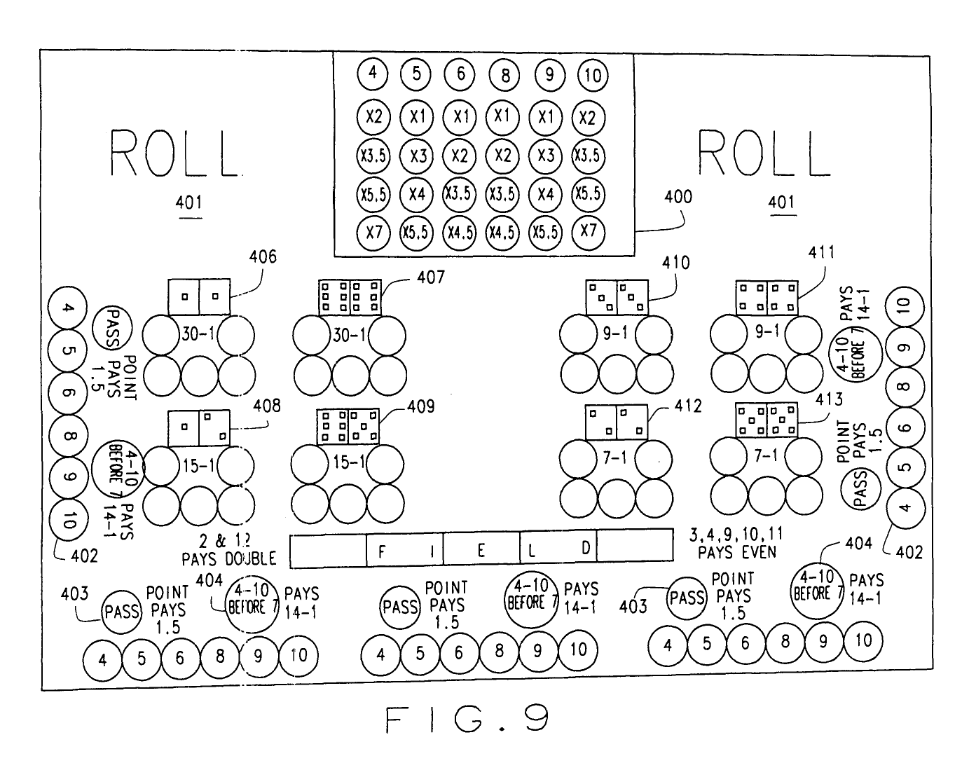

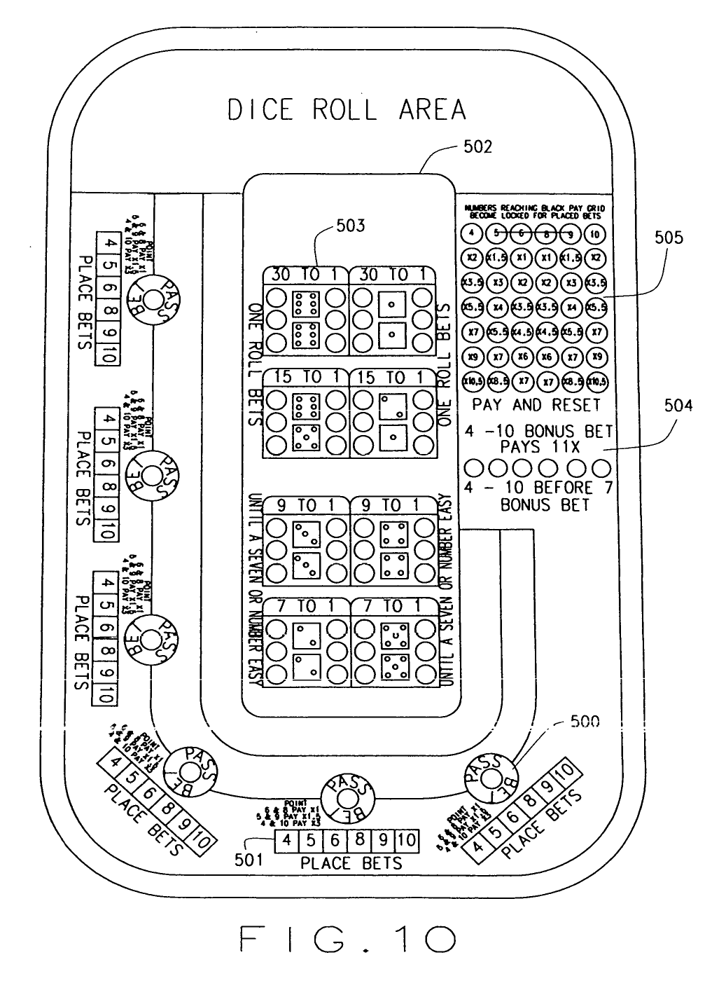

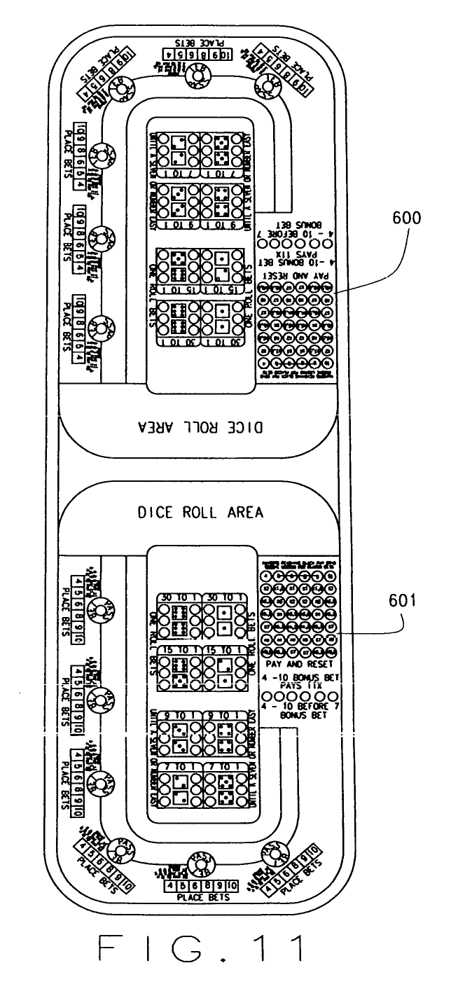

The Game Mat 24″×36″ (approximate) cloth or felt top with game design and rubber backing, (similar to a thick computer mouse pad), can be seen in FIG. 9.

FIG. 9: Pay Grid. Already established multiplier for numbers rolled. Acrylic spacer moves down 1 space at a time as the number is rolled. Simplified process of paying after each number is rolled. (Example) If a number 8 is rolled 3 times before a point or crap out, each player will be paid that multiplier depending on how much they have bet in their color coded placed bet. If a number is rolled 4 times, players are paid out, and the acrylic chip restarts at the top with a $1 chip underneath to acknowledge the number has already been rolled. The process repeats itself. See 400.

Roll Area. There are 2 option locations for this, depending on what side of the game mat you are playing from. Either one is fine. Players must roll in this designated area, and make every attempt to keep dice in these areas to keep form disrupting other chips on the table. See 401.

Placed Bets. Once a point has been established, players have the option to bet these numbers. (Should be made in even dollar increments to maximize payout. Payouts are always rounded down to the nearest dollar). See 402.

Pass Bet. See 403. Players place a wager here at the start of the game. If 7 or 11 comes up on the initial roll they are paid even money. If 2, 3, or 12, come up, they lose this bet, and may replace their bet. Once a point has been established, if the number is rolled, they are paid 1.5 times. PortaCraps does not offer the option to bet against the table or backing of their bet.

4-10 before 7 bonus bet. See 404. This is an optional wager that must be placed at the beginning of any round. If each of the 4-10 numbers come up before a 7 is rolled, players are paid 14-1. This can only be won once a round. (If a player rolls a 7 on the come out roll, this bet may be replaced).

Field Bet. See 405. Optional bet to place at any time. See 405. 3,4,9,10,11 pay even money. 2 and 12 pay double.

Aces (Snake Eyes). See 406. One time wager may be placed at any time. Pays 30-1.

Twelves (Box Cars). See 407. One time wager may be placed at any time. Pays 30-1.

3. One time wager may be placed at any time. Pays 15-1. Shown at I1 through I5. See 408.

11 (Yo). J1 through J5. One time wager may be placed at any time. Pays 15-1. See 409.

Hard 6. Anytime wager, comes down when the number comes easy or a crap out. Pays 9-1. See 410.

Hard 8. Anytime wager, comes down when the number comes easy or a crap out. Pays 9-1. See 411.

Hard 4. See 412. Anytime wager, comes down when the number comes easy or a crap out. Pays 7-1.

N. Hard 10. See 413. Anytime wager, comes down when the number comes easy or a crap out. Pays 7-1.

The various game components, including the portable game mat, can all be compactly assembled in packaging generally as shown in said FIG. 8.

### Packaging

First smaller, inner tube FIG. 8C consists of 90 white poker chips FIGS. 8E through 8H.
Second smaller, inner tube also at 8C, consist of 60 red, 22 green, 6 black poker chips, and 6 acrylic spacers and 2¾ dice as at FIG. 8J.
Game mat, FIG. 9, is laid out with rubber side facing up. 2 smaller, inner tubes are laid end to end, and rolled up tightly inside game mat. Rolled mat with 2 inner tubes is then placed in larger tube FIG. 8A and end caps FIG. 8B and FIG. 8D are put on. FIG. 10 shows a similar type game mat layout. All of these game mats are configured similar to the game mat of FIG. 1.
When putting chips away in smaller tubes, you may need to shake tube vigorously to get them to lay flat. Chips return easier when fewer chips are placed in tube at a time. Total packaging should take approximately 2-5 minutes.

The play of the game, and its system of usage and application, which may lead to rewards, or otherwise, can be best identified as follows.

### Game of Play (Summary and Directions)

Game is played with 2-6 players. 1 dealer (House) and up to 5 players.

For the purpose of the “game”, a player win when:
last player with money from their $100 allotment
most dollars within an agreed upon time frame
most money when and if the bank is broken

The suggested dollar amount allotment or rules may be changed depending on your wants as a group. Additional players can be part of the house, to assist the dealer. A “buy in”, or percentage “buy in” is discouraged unless you are in a location that allows gambling.

Each player starts with $100: 15 white $1 poker chips, 7 red $5 poker chips and 2 green $25 poker chips.

To start the game, each player commits to a color in front of them, which represents all their placed bets. A player must commit to playing the round table by placing a bet in the “pass” circle of their color. (Don't Pass and several other bets are not available in PortaCraps).

Dealer will let you know “Place your bets” when it is time to have hands on the mat to place your bets. Players should not have their hands on the table any time after dealer acknowledges “No more bets”! Dealer may also allow 1 color (Player) at a time if he so chooses.
“Pass” bets should not be in even increments as payout are rounded down to the nearest dollar.

Hard way inside bets and field bets can be made on each individual roll. (Reminder, the 2,3,11,12 hard way bets are on time rolls, and the hard way 4,6,8,10 stay until the number comes easy or a crap out). (Example of a hard 6 is both dice are 3′s, easy are 5 and 1, 4 and 2).

Outside numbers “Placed” bets cannot be made until a point has been established. (Example: 4,5,6,8,9,10).
“Placed” bets should be in even increments as payouts are rounded down to the nearest dollar.

Dice travel in a clockwise direction beginning with the yellow location. Roller should place dice in vinyl end cap 303 from large plastic tube. Cover with their hand and shake 4-5 times, and roll dice at a minimum of 6″ from the game mat, within one of the two “Roll” areas. Both dice need to be rolled at the same time. Roller should make every attempt to keep dice within “Roll” area to avoid disrupting chips on the game mat. If one or both dice do not end up on mat, it is considered a bad roll and both dice are to be rolled again. (Note: dice do not have to end up in “Roll” area, but both must be somewhere on the mat when they come to rest).

In addition to any applicable inside bets, if a 7 or 11 is rolled on the come out roll, the “Pass” spot pays even money. (If the 7 comes up, player loses their 4-10 before 7 bonus bet). This bet can be replaced at this time before the next roll. If a 2, 3 or 12 is rolled on the come out roll, player loses their “Pass” spot bet, but their 4-10 before 7 bonus bet remains. Player has the option to place another

“Pass” bet at this time, and must do so to still be eligible for their bonus bet.

If a point has been established (4,5,6,8,9,10) players can then make their color coded outside “Placed” bets. (Backing your “Pass” bet is not allowed in PortaCraps, but the point is paid at 1.5×). Once you make a “Placed” bet, these bets cannot be removed, increased, or decreased until the point is made. Dealer will place acrylic chip with translucent color on the payout grid as the point to make. As additional numbers are rolled within the payout grid, a clear chip is moved down accordingly. Reminder: inside wagers are made and paid from roll to roll. Outside wagers are paid when a point is made, the number is rolled 4 times (Needs to be reset at the top, or roller craps out (7). When an acrylic chips needs to be reset at the top of the payout grid again by the dealer, a while dollar chip will be placed under the acrylic chip acknowledging that number has been rolled. The purpose of this, is for the 4-10 before 7 bonus bet. The 4-10 before 7 bonus bet, is only paid out once within a round. (Sorry house odds, but you do get your bet back)!

For the purpose of clarification, a “round” is as long as the same roller has the dice.

When a point is rolled, it is a reset and all inside and outside bets are paid accordingly. Haced bets are paid accordingly to the multiplier established and already calculated on the pay grid. Points are paid at 1.5× your “Pass” wager. As a reminder for the come out roll, the only bet that should remain in the outside bets is the bonus bet. (These bets stay until bonus is made or a 7 comes up). See above for bets appropriate at the come out roll. The round ends when a roller craps out. Applicable bets are paid before table is clear.

A new rounds begins with the next roller.

For The Dealer
All players at the table will be responsible for placing their own bets in accordance with the color that is their own dedicated color, for both inside and outside bets. A level of integrity is required for all players.
The only bet not allowed on the come out roll, is the placed numbers. (4, 5, 6, 8, 9, 10) easy.
To participate in the round (Round meaning the dice are with the same roller) a player must place a “Pass” bet before a point is established.
Once a point has been established, the “Pass” and “4-10 before 7 bonus bet” cannot be removed, increased, decreased or modified in any way. It is also the time that players have the option to place their outside placed bets (Even increment for odd purposes). Once the roller is given the okay to roll, these placed wagers cannot be modified for the duration of the roll, until a point is made, or a “7” is rolled (Crap Out).
After each roll, the dealer will progress in the following way:
   Place the acrylic chip over the rolled number (if applicable).
   Take or pay the one time hard way bets and field bets.

Pay or take any of the hard way 4, 6, 8, 10 bets depending on if they hit or come up easy. Easy way the bet comes down and may be bet again by the player.

Reminders that the players are not to adjust their bets at this time.
Players are not paid on the pay grid until 1 of 3 things happens:
   1. Player craps put. (Caution: If a player craps out, do not immediately clear the table, as there may be numbers on the pay grid that need to be accordingly first.
   2. Point is made.
   3. The number has been rolled 4 times on the grid. In this case the players are paid accordingly and the acrylic chip gets reset at the top with a $1 chip underneath to acknowledge it has been rolled. If the number comes up again, the acrylic chip will continue to move down accordingly.

Note that there will be a frequent change of chips between dealer and players

FIG. 9 shows the layout for the portable style of layout for the craps game, including the Pay Grid area 400 of this invention, and each participant is provided with a coloration or other indicia for play, as noted through the reference characters 1-5, for 5 players.

FIG. 10 shows an improved design layout fora non-digital simplified craps game, represented on a stand alone table. Game sample layout incorporates traditional pass bets 500, placed bets 501, field 502, hard ways 503, and bonus bets 504 around playing surface. Improved design concept allows players to have their own unique color coded and or related coded identifier, which enables the players to place their own wagers on the playing surface. This layout incorporates a pay grid 505 directly on the surface of the mat, used to keep track of rolled numbers. Approximate table dimensions are 48″×84″. The 4-10 before 7 bonus bet and pay grid are kept track directly on the playing surface, or by other mechanical means as mentioned in the patent.

FIG. 11 shows the same non-digital layout as in FIG. 10. However, this diagram represents the ability to turn one existing casino craps table into two separate simplified games 600 and 601. Simple table modifications include placing a divider in the center of the table, and simply replacing the felt or other material on the table with the improved layout. Total table dimensions are approximately 48″×168″.

FIG. 12 shows an improved design layout for a digital simplified craps game 700, represented on a stand alone table. Game sample layout incorporates traditional pass bets 701, placed bets 702, field 703, hard ways 704 and 705, and bonus bets 706 around the playing surface. Improved design concept allows players to have their own unique color coded and/or related coded identified, which enables the players to place their own wagers on the playing surface. This layout incorporates a digital monitor 707 above the roll area. The digital display includes the pay grid and bonus bets. Data for the digital display is entered by a dealer from a touch screen input device alongside the table. The streak, combinations bets, and pay grid are easily recorded in a digital format.

FIG. 13 shows the same digital layout as in FIG. 12. However, this diagram represents the ability to turn one existing casino craps table into two separate simplified games 801 and 802. Simple table modifications include placing a divider 803 in the center of the table with a monitor on both sides of the divider. A touch screen input device 804 and 805 will be placed on both sides of the table, and also replacing the felt or other material on the table with the improved layout. Total table dimensions are approximately 48″×168″.

FIG. 14 shows the standard board for the game of craps, as currently utilized in the various casinos, for comparison with respect to the modifications or improvements made through the design of the inventive game as shown and described herein.

Variations or modifications to the subject matter of this invention may occur to those skilled in the art upon review of the invention as described herein. Such variations, if within the spirit of this invention, are intended to be encompassed within the scope of any claims to patent protection issuing hereon. The review of the invention in the Summary, its detailed description in the Specification, and its depiction in the Drawings, are primarily set forth for illustrative purposes only.

I claim:

1. A game board for playing craps, comprising:
said game board having a playing surface on its upper surface thereof, and including player identifying chips and a pair of dice;
said player identifying chips being color coded or containing other indicia to identify a particular player participating in said game;
a first area on said board identified as a pay grid upon said playing surface, and at least once spacer for moving upon said pay grid one space at a time upon each roll of the said pair of dice, and thereby enhancing the pay out to any player participating in said craps game;
a second area on said board identified as a hard ways area which displays the various combination of payments to be collected or made after each roll of the pair of dice;
a third area on said board identified as a further hard way display showing other combinations of numbers that may provide for payment after said roll of said pair of dice;
a fourth area on said board identified as a field and displaying a series of numbers that provide a pay out when said numbers are shown after a roll of the pair of dice;
a fifth area on said board identified as a pass bet area, one pass bet area associated with each player of said craps game and where each player may place a bet with a chip at the start of performance of a craps game;
a sixth area on said board identified as a bonus bet area where select numbers appearing upon a roll of the pair of dice provide a pay out to that player placing a bonus bet upon that area; and
said game board furnishing a roll area upon said board surface where the dice may roll during a play of said craps game.

2. A game board for playing craps, comprising:
said game board having a playing surface on its upper surface thereof, and including a pair of dice;
a first area on said board associated with each of the players of said craps game and said area displaying a series of numbers for personal selection and placing of a bet individually by the player, and upon a roll of the pair of dice provides a payout to the player when the selected number corresponds to the rolled pair of dice; and
a second area on said board identified as a pass bet area, one pass bet area associated with each placed bet area of a player of said craps game and where each player may place a bet with a chip at the start of a craps game when the pass bet selected number corresponds to the number displayed upon the rolled pair of dice.

3. The game board for playing craps of claim 2, and including a third area on said board identified as a pay grid provided upon said playing surface, and a spacer for moving upon said play grid one space at a time upon each roll of the said pair of dice, and thereby enhancing the payout to a successful player participating in said craps game.

4. The game board for playing craps of claim 3, and including a fourth area on said board identified as a bonus bet area where select numbers appearing upon a roll of the pair of dice provide a payout to that player placing a bonus bet upon the game board during performance of a craps game.

5. The game board for playing craps of claim 4, and including a fifth area on said board identified as a field displaying a series of numbers that provide a further payout when said numbers are shown after a roll of the pair of dice.

6. The game board for playing craps of claim 5, and including a sixth area on said board identified as a hard way which displays the various combination of numbers which afford payment to a player when corresponding numbers appear upon the roll of a pair of dice.

7. The game board for playing craps of claim 6, and including a seventh area on said board identified as a further hard way display showing other combination of numbers that may provide payment when the numbers appear after a roll of the pair of dice.

8. The game board for playing craps of claim 7, wherein said board furnishing a roll area upon the said board surface where the dice may roll during performance of the said craps game.

9. A crap game with color-coded or other indicia identifying each player, and providing a system of wagering, including a table or game mat, said game mat having a pay grid area where the participant can be paid from an increasing multiplier established by the pay grid area upon said game mat, said game mat incorporating a roll area, where the dice are rolled by the players sequentially during game play, the game mat incorporating a placed bets area and a pass bets area, and further including field bets areas, where players are provided with various options to place bets upon the identified numbers, or players may designate a pass bet area upon the game mat, wherein when select numbers are identified from the roll of dice, and when select numbers are displayed as selected by the player, the player will win at the game of craps.

10. The craps game of claim 9, wherein a player may locate a wager upon a placed bets area, wherein when the selected numbers appear from the roll of dice, a payout is made to the player that has selected the winning number.

11. The craps game of claim 10, wherein the game is portable.

12. The portable craps game of claim 11, wherein said game includes a series of accessories, including a pair of dice, a series of player identifying chips, at least one spacer, and wherein said game mat is foldable to provide for its storage.

13. The portable craps game of claim 12, and including a tubular container for packaging of the accessories of said craps game during storage.

14. A method of playing a modified game of craps, with a game board having a playing surface thereon, and a pair of rollable dice, comprising:
including at least one player at the game board;
said at least one player making a wager with a player identified chip on a pass bet area of said playing surface;
said player optionally placing a bet on a placed bet area on said playing surface after an initial roll of the dice;
providing a pay grid area operatively associated with said game board and displaying a movable spacer upon said displayed pay grid with each roll of said dice to enhance the game playout if a winner is determined;
rolling the pair of dice in performance of said craps game; and
determining a winner and the amount to be awarded based upon the bets made upon the pass bets area, the placed bets area, and the established pay grid then currently displayed for the game.

15. A method of playing a modified game of craps, including displaying electronically the play grid area operatively associated with the game and the location of its spacer upon identification of a winner and the enhanced payout to the player of the craps game.

16. A method of playing a modified game of craps, as set forth in claim 15, including optionally allowing the player to place bets upon at least one of a field bet that provides for double payment upon selection of a winner, to place a bet upon a bonus bet area, to place bets upon a field bet area, and to place bets upon at least one hard ways betting area provided upon the playing surface that allows the at least one player to bet on various combinations of numbers and payouts indicated upon the playing surface determined upon the roll of the dice.

17. The game board for playing craps of claim 3, wherein said play grid is digitally displayed in association with the game board provided for playing of said game of craps.

18. The game board for playing craps of claim 2, and including a pair of two game boards, said game boards being arranged back-to-back, and a divider provided between the said back-to-back game boards, and digitally displaying the pay grid area of betting.

19. The game board for playing craps of claim 17, and including a touch screen input device operatively associated in proximity with the game dealer, to allow the dealer to input data through a touch screen for display upon the digital pay grid and other bonus bets.

20. The game board for playing craps of claim 18, and including a touch screen input device operatively associated with each of the game boards, to allow the dealer to input data into the digital displays that show the status of the pay grid and other bonus bets during performance of the game of craps.

21. The craps game of claim 9, wherein various mechanical means including a spacer, dials, pegs, sliders, and other mechanical means may be used for displaying information upon the pay grid area to keep track of the number of times of rolled dice, and to identify other bonus bets undertaken by a player.
